(19) United States
(12) Patent Application Publication
(10) Pub. No.: US 2026/0140305 A1
(43) Pub. Date: May 21, 2026

(54) PHOTONIC INTEGRATED CIRCUIT AND METHOD OF MANUFACTURING THE PHOTONIC INTEGRATED CIRCUIT

(71) Applicant: SAMSUNG ELECTRONICS CO., LTD., Suwon-si (KR)

(72) Inventors: Sunil Kim, Suwon-si (KR); Minkyung Lee, Suwon-si (KR); Inoh Hwang, Suwon-si (KR)

(73) Assignee: SAMSUNG ELECTRONICS CO., LTD., Suwon-si (KR)

(21) Appl. No.: 19/247,878

(22) Filed: Jun. 24, 2025

(30) Foreign Application Priority Data
Nov. 19, 2024 (KR) 10-2024-0165643

(51) Int. Cl. G02B 6/12; G02B 6/13

(52) U.S. Cl. CPC G02B 6/12004; G02B 6/13; G02B 2006/12038; G02B 2006/12097; G02B 2006/12104; G02B 2006/12107; G02B 2006/12145; G02B 2006/12147

(57) ABSTRACT

A photonic integrated circuit includes a substrate, an insulating layer on the substrate, an optical device layer on the insulating layer, the optical device layer including an optical coupler, and a reflective layer between the optical coupler and the insulating layer, where the optical device layer further includes hydrogen-containing amorphous silicon.

### CROSS-REFERENCE TO RELATED APPLICATION

This application is based on and claims priority to Korean Patent Application No. 10-2024-0165643, filed on November 19, 2024, in the Korean Intellectual Property Office, the disclosure of which is incorporated by reference herein in its entirety.

### BACKGROUND

### 1. Field

The disclosure relates to a photonic integrated circuit and a method of manufacturing the photonic integrated circuit.

### 2. Description of Related Art

Light detection and ranging (LiDAR) devices may provide information, such as the distance, relative velocity, and azimuth angle of an object around a vehicle, by projecting a laser beam onto a selected region around the vehicle and detecting the reflected laser beam. To this end, LiDAR devices require beam steering techniques to steer light to desired regions.

Beam steering methods may be broadly categorized into mechanical methods and non-mechanical methods. Examples of mechanical beam steering methods include a method of rotating a light source itself, a method of rotating a mirror that reflects light, and a method of moving a spherical lens in a direction perpendicular to an optical axis. Examples of non-mechanical beam steering methods include a method of using a semiconductor device and a method of electrically controlling the angle of reflected light by using a reflective phased array.

Non-mechanical methods have issues such as high optical loss, complex operation, and low light output efficiency of antennas. Thus, solutions for addressing such issues are being sought.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided are a photonic integrated circuit capable of achieving improved efficiency and a method of manufacturing the photonic integrated circuit.

Additional aspects will be set forth in part in the description which follows and, in part, will be apparent from the description, or may be learned by practice of the presented embodiments of the disclosure.

According to an aspect of the disclosure, a photonic integrated circuit may include a substrate, an insulating layer on the substrate, an optical device layer on the insulating layer, the optical device layer including an optical coupler, and a reflective layer between the optical coupler and the insulating layer, where the optical device layer further includes hydrogen-containing amorphous silicon.

The reflective layer may include Au, Al, or Ag.

The reflective layer may include at least one first layer with a first refractive index and at least one second layer with a second refractive index that is different from the first refractive index.

The at least one first layer may include a plurality of first layers, and the at least one second layer may include a plurality of second layers, and the plurality of first layers and the plurality of second layers may be alternately stacked.

The at least one first layer and the at least one second layer may each include silicon (Si), silicon nitride (Si₃N₄), silicon oxide (SiO₂), or titanium oxide (TiO₂).

The hydrogen-containing amorphous silicon may have an extinction coefficient of 1e-5 or less.

The optical device layer may include an optical switch.

The photonic integrated circuit may include a heater configured to drive the optical switch.

The heater may include TiN, W, or Si.

The reflective layer may have a thickness of 100 nm to 1000 nm.

A distance between the reflective layer and the optical coupler may be 1 μm or less.

The optical coupler may include a periodic grating.

The insulating layer may include SiO₂.

The photonic integrated circuit may include a clad layer on the optical device layer.

The clad layer may include SiO₂ or Si₃N₄.

The optical device layer may include an optical waveguide.

The optical waveguide may include a rib waveguide or a strip waveguide.

According to an aspect of the disclosure, a method of manufacturing a photonic integrated circuit may include forming an insulating layer on a substrate, forming a reflective layer on the insulating layer, forming an optical coupler on the reflective layer, the optical coupler including hydrogen-containing amorphous silicon, and forming a clad layer on the optical coupler.

The forming of the optical coupler may include depositing the hydrogen-containing amorphous silicon under process conditions in which a flow rate of H₂ is at least twice a flow rate of SiH₄.

The reflective layer may include a first layer having a first refractive index and a second layer having a second refractive index that is different from the first refractive index, and the first layer and the second layer may each include Si, SiO₂, Si₃N₄, or TiO₂.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a cross-sectional view illustrating a photonic integrated circuit according to one or more embodiments;

FIG. 2 is a cross-sectional view illustrating a photonic integrated circuit according to one or more embodiments;

FIG. 3 is a graph illustrating variations in the extinction coefficient of an optical device for different optical device materials according to one or more embodiments;

FIG. 4 is a graph illustrating variations in the extinction coefficient of an optical device for different flow rates of H₂ according to one or more embodiments;

FIG. 5 is a graph illustrating the efficiency of an optical coupler with respect to the distance between a reflective layer and the optical coupler according to one or more embodiments;

FIG. 6 is a graph comparing loss values of an optical waveguide of a comparative example and an optical waveguide according to one or more embodiments;

FIGS. 7A to 7E are diagrams illustrating a method of manufacturing a photonic integrated circuit according to one or more embodiments;

FIG. 8 is a diagram illustrating a light detection and ranging (LiDAR) device according to one or more embodiments; and

FIGS. 9 and 10 are respectively a side view and a plan view illustrating an example in which a LiDAR device is applied to a vehicle according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, "at least one of a, b, and c," should be understood as including only a, only b, only c, both a and b, both a and c, both b and c, or all of a, b, and c.

Hereinafter, a photonic integrated circuit and a method of manufacturing the photonic integrated circuits will be described according to various embodiments with reference to the accompanying drawings. In the drawings, like reference numerals refer to like elements, and the sizes of elements may be exaggerated for clarity of illustration. The embodiments described herein are for illustrative purposes only, and various modifications may be made therein.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Furthermore, in the following description, when a component is referred to as being “above” or “on” another component, it may be directly on an upper, lower, left, or right side of the other component while making contact with the other component or may be above an upper, lower, left, or right side of the other component without making contact with the other component.

The terms of a singular form may include plural forms unless otherwise mentioned. It will be further understood that the terms “comprises” and/or “comprising” used herein specify the presence of stated features or elements, but do not preclude the presence or addition of one or more other features or elements.

An element referred to with the definite article or a demonstrative determiner may be construed as the element or the elements even though it has a singular form. Operations of a method may be performed in an appropriate order unless explicitly described in terms of order or described to the contrary, and are not limited to the stated order thereof.

Line connections or connection members between elements depicted in the drawings represent functional connections and/or physical or circuit connections by way of example, and in actual applications, they may be replaced or embodied with various additional functional connections, physical connections, or circuit connections.

Examples or exemplary terms are used herein to describe technical ideas and should not be considered for purposes of limitation unless defined by the claims.

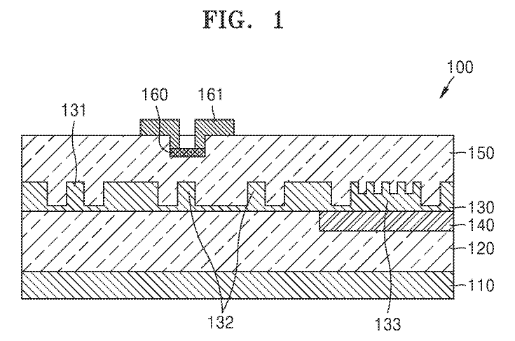

FIG. 1 is a cross-sectional view illustrating a photonic integrated circuit 100 according to one or more embodiments.

Referring to FIG. 1, the photonic integrated circuit 100 may include a substrate 110, an insulating layer 120 provided on the substrate 110, an optical device layer 130 provided on the insulating layer 120 and including an optical coupler 133, and a reflective layer 140 provided under the optical coupler 133. The reflective layer 140 may be provided between the optical layer 130 and the insulating layer 120 and at a location that corresponds to the optical coupler 133. For example, the reflective layer 140 may be relatively aligned with the optical coupler 133. That is, if the optical coupler 133 is positioned to one side of the device, the reflective layer 140 may be under the optical device layer 130 at a position corresponding to the optical coupler 133 (i.e., directly below the optical coupler 133 such that a width of the optical coupler 133 is within a width of the reflective layer 140).

The substrate 110 may include, for example, silicon. However, the material of the substrate 110 is not limited to silicon, and various wafer materials used in semiconductor manufacturing processes may be used to form the substrate 110.

The insulating layer 120 provided on the substrate 110 may insulate the optical device layer 130 and the substrate 110 from each other. The insulating layer 120 may be provided over the entirety of an upper surface of the substrate 110. The insulating layer 120 may include an oxide. The insulating layer 120 may include, for example, SiO₂. However, the insulating layer 120 is not limited thereto and may include a material with a refractive index lower than the refractive index of silicon.

The insulating layer 120 may have a thickness for increasing the efficiency of the optical coupler 133. For example, the thickness of the insulating layer 120 may range from about 100 nm to about 5 μm.

The optical device layer 130 is a layer for implementing optical devices that operate electrically. The optical device layer 130 may include, for example, an optical waveguide 131, an optical switch 132, and the optical coupler 133. However, the optical device layer 130 is not limited thereto and may include various types of optical devices.

The optical device layer 130 may include a semiconductor material. The optical device layer 130 may include hydrogen-containing amorphous silicon. The optical waveguide 131, the optical switch 132, and the optical coupler 133 may include hydrogen-containing amorphous silicon. Because the optical device layer 130 includes hydrogen-containing amorphous silicon, the optical device layer 130 may be used alternatively to silicon-on-insulator (SOI) substrates, thereby reducing process costs.

The hydrogen-containing amorphous silicon may be deposited by plasma enhanced chemical vapor deposition (PECVD) or low pressure chemical vapor deposition (LPCVD). The hydrogen-containing amorphous silicon may be heat treated immediately after the hydrogen-containing amorphous silicon is deposited. Thus, the hydrogen-containing amorphous silicon may have an amorphous or polycrystalline structure.

In the hydrogen-containing amorphous silicon, defects in amorphous silicon may be passivated by hydrogen, and thus, the amorphous silicon may have a low extinction coefficient k. As a result, the optical loss of light passing through the optical device layer 130 may be reduced. For example, the extinction coefficient k of the hydrogen-containing amorphous silicon may be 1e-5 or less.

The optical waveguide 131 may be formed by partially patterning the optical device layer 130. FIG. 1 illustrates an example in which the optical waveguide 131 is of a rib waveguide type having a pattern partially etched in the thickness direction thereof. However, embodiments are not limited thereto. The optical waveguide 131 may include, for example, a strip waveguide.

The optical switch 132 may route optical signals. The optical switch 132 may be driven by n-type doping and p-type doping according to electro-optic properties.

The optical coupler 133 may include a periodic grating formed by patterning the optical device layer 130. The periodic grating may include protrusions that are spaced apart by the same predetermined distances. The optical coupler 133 may be configured to receive light from the outside of the photonic integrated circuit 100 or output light from the inside of the photonic integrated circuit 100.

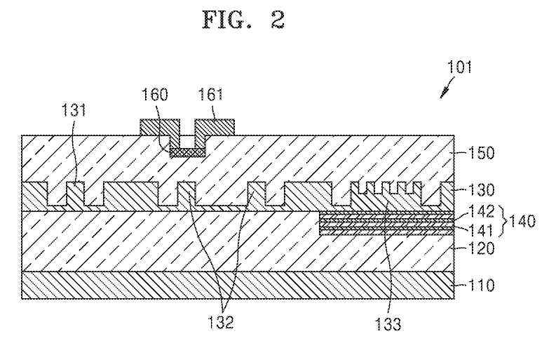

The reflective layer 140 may be provided on the insulating layer 120 in a region in which the optical coupler 133 is to be provided. The reflective layer 140 may be provided under the optical coupler 133. The reflective layer 140 may be a metallic reflective layer. The reflective layer 140 may include, for example, Au, Al, or Ag. For example, the reflective layer 140 may have a thickness of about 100 nm to about 1000 nm. The reflective layer 140 may have a structure other than a metallic reflective layer. For example, the reflective layer 140 may include a distributed Bragg reflector (DBR). This is described below with reference to FIG. 2.

FIG. 1 illustrates that the optical coupler 133 and the reflective layer 140 directly contact each other. However, the optical coupler 133 and the reflective layer 140 are not limited thereto, and an oxide may be provided between the optical coupler 133 and the reflective layer 140. In this case, there may be a slight gap between the optical coupler 133 and the reflective layer 140, and the oxide may be provided in the gap. The oxide may include the same material as the insulating layer 120. For example, the oxide may include SiO₂.

For example, the distance between the reflective layer 140 and the optical coupler 133 may 1 μm or less. For example, the distance between the reflective layer 140 and the optical coupler 133 may 0.5 μm or less. The reflective layer 140 and the optical coupler 133 may contact each other.

A clad layer 150 may be provided on the optical device layer 130 to confine light within the optical device layer 130 and dissipate heat generated in the optical device layer 130 to the outside. The clad layer 150 may completely cover the optical device layer 130. The clad layer 150 may act as a protective layer to protect the optical devices formed in the optical device layer 130.

The clad layer 150 may include a material with a refractive index lower than the refractive index of silicon. The clad layer 150 may include, for example, SiO₂ or Si₃N₄. For example, the clad layer 150 may have a thickness of about 1 μm to about 3 μm.

The photonic integrated circuit 100 may further include a heater 160 and metal wiring 161 to drive the optical switch 132. The heater 160 may have a function of finely adjusting optical switching. The heater 160 may include, for example, TiN, W, or Si.

According to one or more embodiments, the reflective layer 140 formed under the optical coupler 133 may increase the efficiency of the optical coupler 133 by reflecting light leaking under the optical coupler 133. In addition, because the reflective layer 140 is not formed on regions of the optical device layer 130 other than a region in which the optical coupler 133 is formed, optical loss may be prevented.

FIG. 2 is a view illustrating a photonic integrated circuit 101 according to one or more embodiments.

Referring to FIG. 2, the photonic integrated circuit 101 may include a substrate 110, an insulating layer 120 provided on the substrate 110, an optical device layer 130 provided on the insulating layer 120 and including an optical coupler 133, and a reflective layer 140 provided under the optical coupler 133.

The reflective layer 140 may be a DBR. The reflective layer 140 may include a first layer 141 and a second layer 142 that have different refractive indexes from each other. The first and second layers 141 and 142 may be alternately and repeatedly stacked. Although FIG. 2 illustrates that the first and second layers 141 and 142 are alternately stacked and each repeated three times, embodiments are not limited thereto. For example, the first and second layers 141 and 142 may be alternately stacked two to five times. That is, a plurality of first layers 141 and a plurality of second layers 142 may be alternately stacked.

Similar to that described above, the reflective layer 140 (including one or more first layers 141 and one or more second layers 142) may be provided between the optical layer 130 and the insulating layer 120 and at a location that corresponds to the optical coupler 133. For example, the reflective layer 140 may be relatively aligned with the optical coupler 133. That is, if the optical coupler 133 is positioned to one side of the device, the reflective layer 140 may be under the optical device layer 130 at a position corresponding to the optical coupler 133 (i.e., directly below the optical coupler 133 such that a width of the optical coupler 133 is within a width of the reflective layer 140).

Because the first and second layers 141 and 142 have different refractive indexes from each other, light may be reflected at interfaces between the first and second layers 141 and 142, and reflected light waves may interfere with each other. The first and second layers 141 and 142 may each include, for example, silicon (Si), silicon nitride (Si₃N₄), silicon oxide (SiO₂), titanium oxide (TiO₂), or the like. For example, the first layer 141 may include silicon (Si), and the second layer 142 may include silicon oxide (SiO₂). For example, the first layer 141 may include silicon nitride (Si₃N₄), and the second layer 142 may include silicon oxide (SiO₂). The optical reflectivity of the reflective layer 140 may be designed by adjusting the thicknesses and/or stacking numbers of the first and second layers 141 and 142.

The photonic integrated circuit 101 shown in FIG. 2 may be the same as the photonic integrated circuit 100 shown in FIG. 1 except that the reflective layer 140 includes the first and second layers 141 and 142 having different refractive indexes from each other. The same description as that given with reference to FIG. 1 is omitted from the description given with reference to FIG. 2.

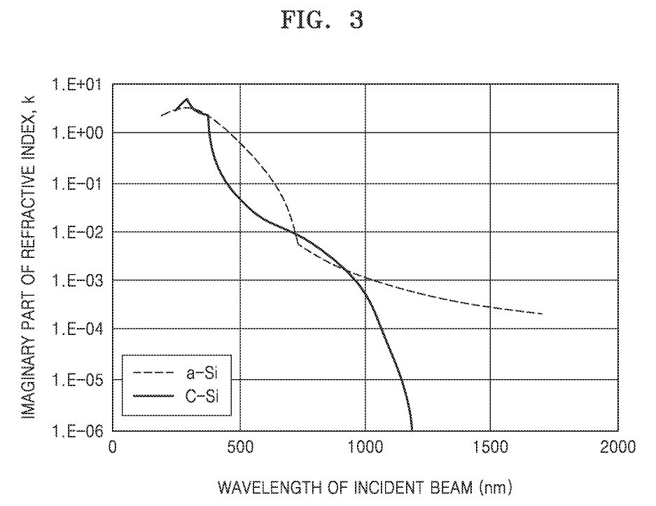

FIG. 3 is a graph illustrating variations in the extinction coefficient of an optical device for different optical device materials according to one or more embodiments;

Referring to FIG. 3, the imaginary part of the refractive index k of amorphous silicon and the imaginary part of the refractive index k of crystalline silicon may be compared with each other. Each of the imaginary parts of the refractive indexes k refer to an extinction coefficient. In a 1550 nm wavelength region, amorphous silicon usually exhibits a greater extinction coefficient than crystalline silicon, indicating that optical devices using amorphous silicon experience greater optical loss than optical devices using crystalline silicon.

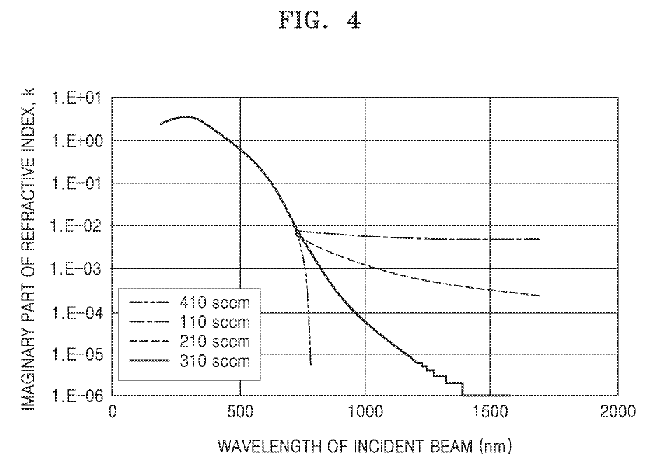

The optical loss of optical devices may be reduced by the use of hydrogen-containing amorphous silicon. The hydrogen-containing amorphous silicon is described below with reference to FIG. 4.

FIG. 4 is a graph illustrating variations in the extinction coefficient of an optical device for different flow rates of H₂ according to one or more embodiments.

Referring to FIG. 4 variations in the extinction coefficient k of the optical device including hydrogen-containing amorphous silicon were measured with respect to wavelength while varying the flow rate of H₂. The extinction coefficient k may be reduced by varying the flow rate ratio of H₂ and SiH₄. For example, variations in the extinction coefficient k were measured with respect to wavelength at a fixed SiH₄ flow rate of 55 sccm while increasing the flow rate of H₂ to 110 sccm, 210 sccm, 310 sccm, and 410 sccm. Through this, as the flow rate ratio of H₂ to SiH₄ increases, the extinction coefficient k decreases. In addition, when the flow rate of H₂ is about at least six times the flow rate of SiH₄, the extinction coefficient k of the optical device is similar to the extinction coefficient k of crystalline silicon in a 1550 nm wavelength region.

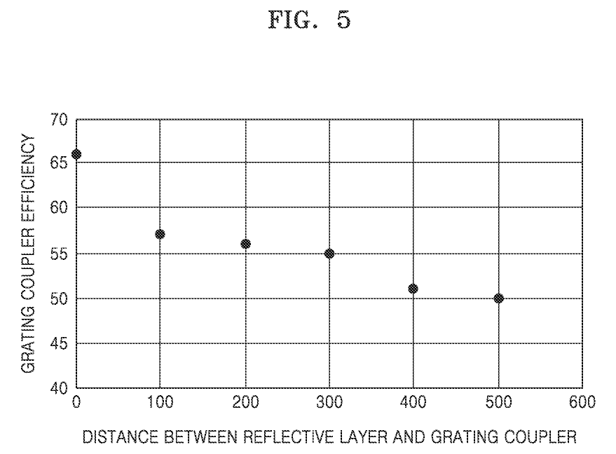

FIG. 5 is a graph illustrating the efficiency of an optical coupler with respect to the distance between a reflective layer and the optical coupler according to one or more embodiments.

Referring to FIG. 5, when the reflective layer and the optical coupler contact each other, the optical coupler shows an efficiency of about 66 % in a 1550 nm wavelength region. The efficiency of about 66 % is greater than 50% efficiency of the optical coupler in the 1550 nm wavelength region when the reflective layer is not provided. In addition, as the distance between the reflective layer and the optical coupler increases, the efficiency of the optical coupler decreases.

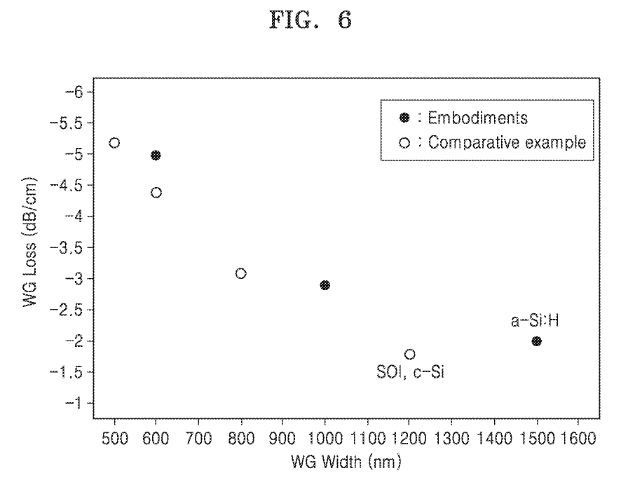

FIG. 6 is a graph comparing loss values of an optical waveguide of a comparative example and an optical waveguide according to one or more embodiments.

Referring to FIG. 6, the optical waveguide of the comparative example includes crystalline silicon on an SOI substrate, while the optical waveguide of one or more embodiments includes hydrogen-containing amorphous silicon.

The optical waveguide of one or more embodiments shows a loss value of about 3 dB/cm for a width of 1 μm, which is similar to the loss value of the optical waveguide of the comparative example. The loss values are similar across all waveguide widths. This demonstrates that the use of hydrogen-containing amorphous silicon in optical devices instead of SOI substrates enables the manufacture of optical devices with similar performance at lower costs

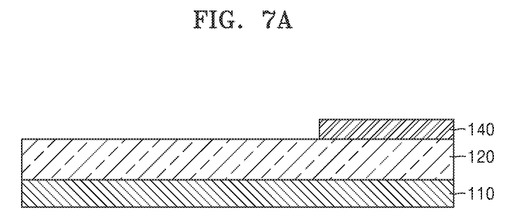

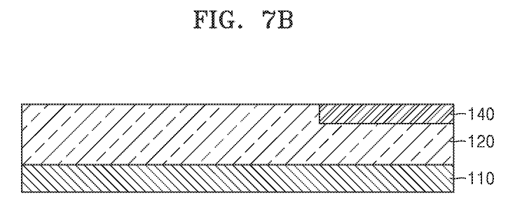

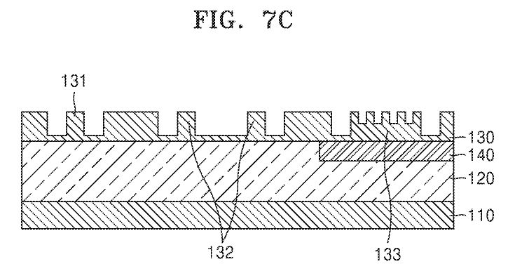

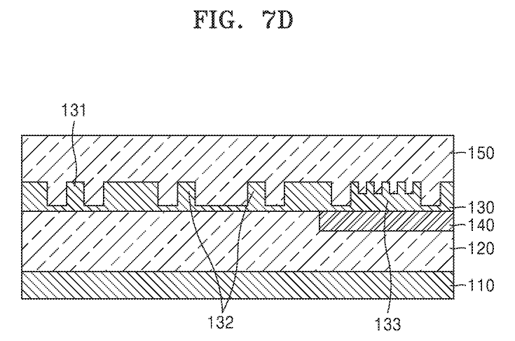

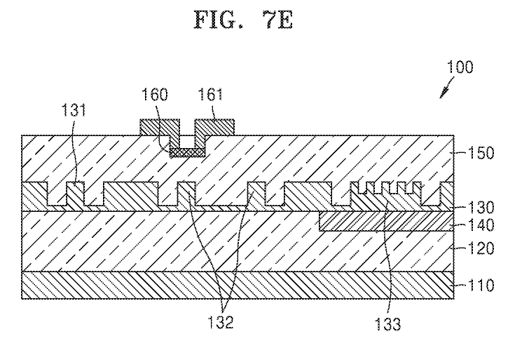

FIGS. 7A to 7E are views illustrating a method of manufacturing a photonic integrated circuit according to one or more embodiments;

Referring to FIG. 7A, an insulating layer 120 is formed on a substrate 110. The insulating layer 120 may include SiO₂. A reflective layer 140 is formed on a region of the insulating layer 120. For example, the reflective layer 140 is formed on a region of the insulating layer 120 on which an optical coupler 133 is to be formed. The reflective layer 140 may be a metallic reflective layer. The reflective layer 140 may include, for example, Au, Al, or Ag. The reflective layer 140 may be a DBR. The reflective layer 140 may include a first layer 141 and a second layer 142 (e.g., FIG. 2) that have different refractive indexes from each other. The first layer 141 and the second layer 142 may be alternately and repeatedly stacked.

Referring to FIG. 7B, after the reflective layer 140 is formed, insulating layer deposition and planarization are performed on a region on which the reflective layer 140 is not formed, thereby eliminating a height difference between the reflective layer 140 and the insulating layer 120.

Referring to FIG. 7C, an optical device layer 130 is formed on the insulating layer 120. The optical device layer 130 may include an optical waveguide 131, an optical switch 132, and the optical coupler 133. The optical device layer 130 may include hydrogen-containing amorphous silicon. The optical waveguide 131, the optical switch 132, and the optical coupler 133 may include hydrogen-containing amorphous silicon. The hydrogen-containing amorphous silicon may be deposited under a process condition in which the flow rate of H₂ is, for example, at least twice the flow rate of SiH₄. The hydrogen-containing amorphous silicon may also be deposited under a process condition in which the flow rate of H₂ is, for example, at least six times the flow rate of SiH₄.

The optical coupler 133 may be provided on the reflective layer 140. The optical coupler 133 may include a periodic grating formed by patterning the optical device layer 130.

Referring to FIG. 7D, a clad layer 150 is formed on the optical device layer 130. The clad layer 150 may completely cover the optical device layer 130. The clad layer 150 may act as a protective layer to protect optical devices formed in the optical device layer 130.

Referring to FIG. 7E, a heater 160 and metal wiring 161 for driving the optical switch 132 are formed. The heater 160 may have a function of finely adjusting optical switching. The heater 160 may include, for example, TiN, W, or Si.

According to the photonic integrated circuit manufacturing method of the embodiment, the optical device layer 130 includes hydrogen-containing amorphous silicon, and thus, SOI substrates of the related art may be replaced, thereby reducing process costs.

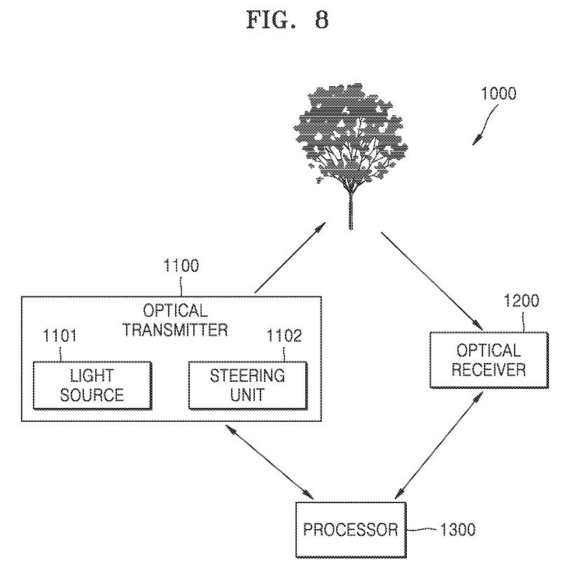

FIG. 8 is a diagram illustrating a light detection and ranging (LiDAR) device 1000 according to one or more embodiments.

Referring to FIG. 8, the LiDAR device 1000 may include an optical transmitter 1100 configured to project light onto a target, an optical receiver 1200 configured to receive light reflected from the target, and a processor 1300 configured to perform calculations to obtain information about the target from the light received by the optical receiver 1200. The optical transmitter 1100, the optical receiver 1200, and the processor 1300 may be implemented as separate devices or as a single device.

The optical transmitter 1100 may include a photonic integrated circuit to project light in a desired direction. The photonic integrated circuit may be the same as any one of the photonic integrated circuits 100 and 101 described with reference to FIGS. 1 and 2. The optical transmitter 1100 may include a light source 1101 configured to generate light and a steering unit 1102 configured to steer the light output from the light source 1101 toward the target.

The light source 1101 may be a wavelength-tunable light source capable of adjusting the wavelength of light when emitting light. A plurality of laser beams may be emitted from the light source 1101, and among the plurality of laser beams, laser beams having mutual coherence may be incident on the steering unit. The light source 1101 may generate and output light in a plurality of different wavelength bands. In addition, the light source 1101 may generate and output pulsed or continuous light. The light source 1101 may include a laser diode (LD), an edge-emitting laser, a vertical-cavity surface-emitting laser (VCSEL), a distributed feedback laser, a light-emitting diode (LED), a super luminescent diode (SLD), or the like.

The steering unit 1102 may illuminate the target by changing the propagation direction of light emitted from the light source 1101. To this end, the steering unit 1102 may include an optical phased array device capable of controlling the direction of light without mechanical movement. The steering unit 1102 may transmit amplified light toward a local area ahead by a one-dimensional or two-dimensional scanning method. To this end, the steering unit 1102 may steer narrowly condensed light, either sequentially or non-sequentially, across one-dimensional or two-dimensional areas ahead at regular time intervals. For example, the steering unit 1102 may be configured to output laser light, either from bottom to top or top to bottom, across one-dimensional areas ahead. In addition, the steering unit 1102 may be configured to output laser light, either from left to right or right to left, across one-dimensional areas ahead.

The optical receiver 1200 may include a photonic integrated circuit configured to receive light reflected from the target and generate an electrical signal based on the received light. The photonic integrated circuit may be the same as any one of the photonic integrated circuits 100 and 101 described with reference to FIGS. 1 and 2. The optical receiver 1200 may include an array of optical detection elements.

The processor 1300 may perform calculations to obtain information about the target from light received by the optical receiver 1200. Additionally, the processor 1300 may comprehensively manage processing and control operations of the LiDAR device 1000. The processor 1300 may acquire and process information about the target. For example, the processor 1300 may acquire and process two-dimensional or three-dimensional image information. The processor 1300 may comprehensively control operations of the optical transmitter 1100 and the optical receiver 1200. For example, the processor 1300 may control electrical signals applied to the optical phased array device of the steering unit 1102. The processor 1300 may also analyze data, such as the distance to the target and the shape of the target, based on numerical information provided by the optical receiver 1200.

Three-dimensional images acquired by the processor 1300 may be transmitted to other units for utilization. For example, such information may be transmitted to a processor of an autonomous driving device such as an autonomous vehicle or an autonomous drone that employs the LiDAR device 1000. In addition, such information may be utilized in smartphones, mobile phones, personal digital assistants (PDAs), laptops, personal computers (PCs), wearable devices, and other mobile or non-mobile computing devices.

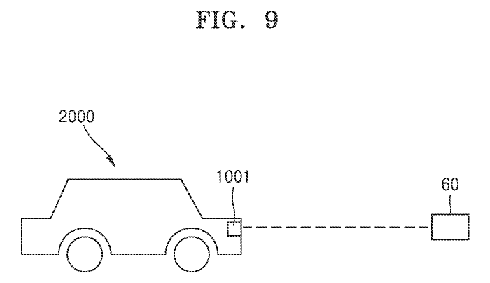

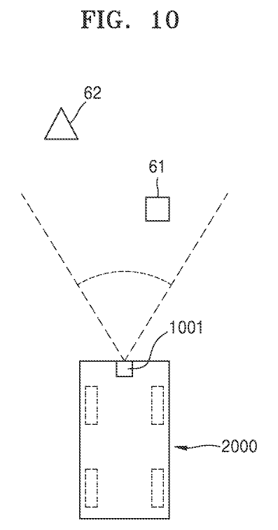

FIGS. 9 and 10 are respectively a side view and a plan view illustrating an example in which a LiDAR device 1001 is applied to a vehicle 2000 according to one or more embodiments.

Referring to FIG. 9, the LiDAR device 1001 may be applied to the vehicle 2000 to obtain information about an object 60. The LiDAR device 1001 may be the LiDAR device 1000 described with reference to FIG. 8. The LiDAR device 1001 may use a time-of-flight (TOF) method to obtain information about the object 60. The vehicle 2000 may be an autonomous vehicle. The vehicle 2000 may use the LiDAR device 1001 to detect objects or people such as the object 60 in a direction of travel and measure the distance to the object 60 using information such as a time difference between signal transmission and signal detection. In addition, as shown in FIG. 10, information about a nearby object 61 and a distant object 62 within a target field (TF) may be obtained.

Although FIGS. 9 and 10 illustrate an example in which the LiDAR device 1001 is applied to an automobile, embodiments are not limited thereto. The LiDAR device 1001 may be applied to flying objects such as drones, mobile devices, small walking aids (for example, bicycles, motorcycles, strollers, boards, etc.), robots, assistive devices for humans/animals (for example, canes, helmets, accessories, clothing, watches, bags, etc.), Internet of things (IoT) devices/systems, security devices/systems, and the like.

As described above, the disclosure provides a photonic integrated circuit with a high grating coupler efficiency is provided by arranging a reflective layer under a grating coupler (optical coupler).

In addition, the disclosure provides a method of manufacturing a photonic integrated circuit with reduced process costs.

According to the photonic integrated circuit and the photonic integrated circuit manufacturing method of the disclosure, the reflective layer is provided under the grating coupler. Thus, the photonic integrated circuit may have a high grating coupler efficiency.

Each of the embodiments provided in the above description is not excluded from being associated with one or more features of another example or another embodiment also provided herein or not provided herein but consistent with the disclosure.

While aspects have been described according to embodiments with reference to the accompanying drawings, it will be understood by those of ordinary skill in the art that the photonic integrated circuit and the photonic integrated circuit manufacturing method are merely examples, and various modifications and other equivalent embodiments may be made therein. Therefore, the embodiments described herein should be considered in a descriptive sense only and not for purposes of limitation. The scope of the disclosure is defined not by the above description but by the following claims, and all differences within equivalent ranges of the scope of the disclosure should be considered as being included in the scope of the disclosure.

What is claimed is:

1. A photonic integrated circuit comprising:
a substrate;
an insulating layer on the substrate;
an optical device layer on the insulating layer, the optical device layer comprising an optical coupler; and
a reflective layer between the optical coupler and the insulating layer,
wherein the optical device layer further comprises hydrogen-containing amorphous silicon.

2. The photonic integrated circuit of claim 1, wherein the reflective layer comprises Au, Al, or Ag.

3. The photonic integrated circuit of claim 1, wherein the reflective layer comprises at least one first layer with a first refractive index and at least one second layer with a second refractive index that is different from the first refractive index.

4. The photonic integrated circuit of claim 3, wherein the at least one first layer comprises a plurality of first layers, and the at least one second layer comprises a plurality of second layers, and
wherein the plurality of first layers and the plurality of second layers are alternately stacked.

5. The photonic integrated circuit of claim 3, wherein the at least one first layer and the at least one second layer each comprise silicon (Si), silicon nitride (Si₃N₄), silicon oxide (SiO₂), or titanium oxide (TiO₂).

6. The photonic integrated circuit of claim 1, wherein the hydrogen-containing amorphous silicon has an extinction coefficient of 1e-5 or less.

7. The photonic integrated circuit of claim 1, wherein the optical device layer further comprises an optical switch.

8. The photonic integrated circuit of claim 7, further comprising a heater configured to drive the optical switch.

9. The photonic integrated circuit of claim 8, wherein the heater comprises TiN, W, or Si.

10. The photonic integrated circuit of claim 1, wherein the reflective layer has a thickness of 100 nm to 1000 nm.

11. The photonic integrated circuit of claim 1, wherein a distance between the reflective layer and the optical coupler is 1 μm or less.

12. The photonic integrated circuit of claim 1, wherein the optical coupler comprises a periodic grating.

13. The photonic integrated circuit of claim 1, wherein the insulating layer comprises SiO₂.

14. The photonic integrated circuit of claim 1, further comprising a clad layer on the optical device layer.

15. The photonic integrated circuit of claim 14, wherein the clad layer comprises SiO₂ or Si₃N₄.

16. The photonic integrated circuit of claim 1, wherein the optical device layer further comprises an optical waveguide.

17. The photonic integrated circuit of claim 16, wherein the optical waveguide comprises a rib waveguide or a strip waveguide.

18. A method of manufacturing a photonic integrated circuit, the method comprising:
forming an insulating layer on a substrate;
forming a reflective layer on the insulating layer;
forming an optical coupler on the reflective layer, the optical coupler comprising hydrogen-containing amorphous silicon; and
forming a clad layer on the optical coupler.

19. The method of claim 18, wherein the forming of the optical coupler comprises depositing the hydrogen-containing amorphous silicon under process conditions in which a flow rate of H₂ is at least twice a flow rate of SiH₄.

20. The method of claim 18, wherein the reflective layer comprises a first layer having a first refractive index and a second layer having a second refractive index that is different from the first refractive index, and
wherein the first layer and the second layer each comprise Si, SiO₂, Si₃, N₄, or TiO₂.
